(19) United States
(12) Patent Application Publication
(10) Pub. No.: US 2007/0240897 A1
(43) Pub. Date: Oct. 18, 2007

(54) Bi-Metallic Connectors, Method for Producing the Same, and Method for Connecting the Same to a Structure

(75) Inventors: Oren Gafri, Rishon Le-Zion (IL); Yuri Livshiz, Rishon Le-Zion (IL)

Correspondence Address: NATH & ASSOCIATES, 112 South West Street, Alexandria, VA, 22314, US

(73) Assignee: PULSAR WELDING LTD., Yavne (IL)

(21) Appl. No.: 11/629,629

(22) PCT Filed: Jun. 15, 2005
(86) PCT No.: PCT/IL05/00635

§ 371 Date: Apr. 6, 2007

Related U.S. Application Data
(60) Provisional application No. 60/580,107, filed on Jun. 17, 2004.

(51) Int. Cl. H01R 4/62; B21D 26/14

(52) U.S. Cl. 174/94 R; 29/876

(57) ABSTRACT

A bimetallic connecting element has a first part made from a first metal, and a portion of this part is adapted for being attached to a structure. A second portion of this part has a peripheral wall defining a cavity. A second part of the connector is made from a second metal, and has a third portion concentrically received with respect to the cavity and fixed with respect to the first part by means of a pulse magnetic forming (PMF) process, in which the peripheral wall is impacted onto said third portion. The second part of the connector has a fourth portion adapted for attaching thereto a component made from a third metal. The structure onto which the connector is to be fixed, typically by welding, is made from a fourth metal that is weld-compatible with said first metal. A method is also disclosed for connecting a bimetallic connector to a structure to enable a component made from a metal that is not compatible with the structure to be connected to the structure.

### FIELD OF THE INVENTION

This invention relates to bimetallic connectors comprised of components made from metals having different properties, and more specifically to such connectors designed to enable other components to be attached to a structure such as for example a vehicular or machine body and/or chassis via the connectors. The invention also relates to a method for manufacturing such connectors and to a method for joining such connectors to a structure.

### BACKGROUND OF THE INVENTION

Bimetallic components are known in the prior art and are disclosed in the following publications, for example.

In U.S. Pat. No. 3,916,518, an elbow-type terminator for electrically connecting an insulated aluminum conductor wire to a copper terminal accommodates a one-piece bimetallic aluminum-copper connector. The connector comprises an aluminum portion and a copper portion welded together across their entire interface by an inertia welding process. A method for making the one-piece bimetallic connector broadly comprises the steps of providing a cylindrical copper blank and a cylindrical aluminum blank, heat treating the aluminum blank, cleaning those faces of the blanks which are to be welded, welding the two blanks together by an inertia welding process and machining the joined blanks into a connector of desired shape.

In JP 8338413, a steel bolt is disclosed having a main body whose head forms a lower bearing surface. A metal alloy consisting of an aluminium side and a steel side is arranged on the bearing surface. The steel side top surface is connected to the bearing surface by applying stud weld. An aluminum member is connected to the lower surface of the aluminium side by spot welding.

In EP 666614, a bimetallic connector comprises an aluminium part and a copper part connected together typically by friction welding, and extending in opposite directions from the bimetallic joint. The joint is located in an intermediate portion of the connector and adapted for attachment to a connector installation means. The aluminium part is provided with a first blade which (a) occupies a substantially axially centered wide area; (b) has two parallel opposite surfaces forming a thickness smaller than that of the intermediate portion; and (c) is provided with at least one passage extending between said opposite surfaces. The copper part is provided with a second blade having at least one orifice.

In SU 979069, a method for manufacturing bi-metal contact bolts is disclosed, which involves the operations of cropping the contact blanks from plastic metal with high contact properties, the seating of a stud with a head and the cylindrical recessing of metal into the head. The method can be effected more economically when the outer surface of the stud bead is made conical and as it is pressed through a mandrel and the outside diameter is pressed parallel. The inner recess takes on the form of a conical diameter into which the insert to the head can be pressed with the next operation.

In U.S. Pat. No. 5,981,921 and U.S. Pat. No. 6,379,254, a method for securing components of a vehicular driveshaft includes disposing a neck of an end fitting into the open end of a driveshaft tube. The end fitting is held with respect to the driveshaft tube so that an annular gap is formed between the neck and the driveshaft tube. An inductor is provided about the driveshaft tube adjacent the end receiving the neck. The inductor is energized to generate a magnetic field for collapsing the driveshaft tube about the neck at a high velocity so that the driveshaft tube and the end fitting are welded to each other. The end fitting includes a body that is adapted to be received within the tubular member. The body includes an outer surface having a first portion that extends generally axially and a second portion that extends generally radially from the first portion. The outer surface includes a pocket formed in the second portion. The end fitting further includes a pair of arms extending from the body portion and having aligned apertures formed therethrough.

U.S. Pat. No. 5,824,998, assigned to the present Assignee, a method is disclosed of joining two workpieces, by means of a pulsed magnetic force so as to impact one workpiece onto the other.

### SUMMARY OF THE INVENTION

The term “metal” herein includes any metallic substance, whether comprising a single elemental metal, or a mixture of metals and/or alloys, or an alloy or a mixture of alloys, and so on.

The term “compatibility” herein relates to two metals which are capable of being immovably joined together, for example by being welded, bolted or riveted together, in which corrosion at the interface between the two metals is substantially absent or at least below predetermined unacceptable threshold levels, and/or wherein the mechanical integrity of the join between the two metals is not compromised by the method of joining the two metals. Thus, compatibility may be found, for example when welding together two metallic components made from the same metal, for example aluminium on aluminium, copper on copper, brass on brass, and so on, or wherein the two metals belong to the same family of alloys including the base metal thereof, for example one aluminium alloy welded to another aluminium alloy, or indeed some special pairs of metals which are not of the same family.

The term “metal family” is herein taken to include a collection or group of metal alloys having a common base metal, the group also including the base metal itself.

The term “structure” herein refers to any type of structure, body, element, component and so on, such as a chassis or metal body, which form part of any vehicle such as ship, road vehicle, aircraft, spacecraft or any other type of vehicle, for example the hull of a ship, external skin and/or internal structure of an aircraft, satellite, spaceship, missile, and so on; or indeed any substantially static structure, such as for example an aluminium dwelling or enclosure, or a dynamic structure such as a swinging bridge, for example, made from said fourth metal which is typically the same metal or from the same family of metals as the first metal, by means of welding, riveting, bolting and so on.

The present invention relates in a first aspect thereof to a bimetallic connecting element, comprising:

a first part made from a first metal, and having a first portion adapted for being, typically fixedly, attached to a structure, and a second portion comprising a peripheral wall defining a cavity; and

a second part made from a second metal, and having a third portion concentrically received with respect to said cavity and fixed with respect to said first part by means of a pulse magnetic forming (PMF) process comprising impacting said peripheral wall onto said third portion, and a fourth portion adapted for attaching thereto another component made from a third metal;

wherein said structure is made from a fourth metal that is compatible with said first metal. In particular, the fourth metal is compatible for forming a mechanically strong weld that is resistant to galvanic corrosion originating from the contact between the fourth metal and the first metal.

Alternatively, rather than being adapted for connection to another component made from a third metal, the fourth portion may be of a particular form that is of particular importance for a given application. For example, the fourth portion may be in the form of a turbine blade, and thus represent a high value item.

The cavity comprises a concavity for coaxially aligning said second part with respect to said first part, and the third portion is coaxially receivable in said concavity.

In one embodiment, the first portion comprises a plurality of spaced toes longitudinally projecting therefrom in a direction opposed to the said second part. The first portion is adapted for being fixedly attached to another component by forming suitable welds between said toes and said component.

In another embodiment, the first portion comprises a peripheral flange circumscribing a longitudinal end of the said first part opposed to said second part. The first portion is adapted for being fixedly attached to a structure by forming a suitable weld therebetween by means of any suitable welding method. The welding method may comprise, for example, any one of fusion welding, beam welding, resistance welding, solid state welding, and the like. In particular, the welding method may comprise any one of GTAW (gas tungsten arc welding), GMAW (gas metal arc welding), LBW (laser beam welding), EBW (electron beam welding), RSW (resistance spot welding, SW (seam welding), PW (protection welding). PRW (pulse resistance welding), stud welding, FRW (friction rotating welding), FOW (forge welding), friction stir welding, friction spot welding, and so on.

Thus, in one particular embodiment, the first part is partially solid or fully solid (substantially non-hollow), and comprises said toes for welding onto the structure. In another particular embodiment, the first part is also solid and comprises a base for welding, bolting or riveting onto the structure using any suitable method. In yet another particular embodiment, the first part is hollow, and is typically welded to the structure by friction welding, or by any other suitable welding process.

In other embodiments, the first portion may be adapted in different ways for attachment to a structure or other components, for example by means of bolting, riveting, and so on.

Optionally, the fourth portion comprises a screw thread for enabling another component to be attached thereto. Optionally, the fourth portion comprises a flattened section having a bore for enabling another component to be attached thereto. Further optionally, the third portion comprises an annular face juxtaposed with said fourth portion for enabling another component to be seated and attached thereto. Optionally, the fourth portion adapted for welding thereto another component.

Typically, the first metal and said second metal have substantially different properties, for example different electrical conductivities one from the other. However, it is also possible to provide bimetallic components according to the present invention when the first metal and the second metal are in fact the same metal. Such an application of the invention may have advantages, for example, when, say, a user has a quantity of items (first parts) which are high value parts, and which need to be retrofitted with a different end fitting to what they were manufactured with, but made from the same metal as the first parts. Such high value first parts may include, for example, gas turbine blades.

Typically, the first metal is chosen from among, but is not limited to, aluminium, aluminium alloys, copper, copper alloys, brass, steel, stainless steel, low carbon steel, titanium, titanium alloys, and so on. Typically, the second metal, is chosen from among but not limited to stainless steel, steel, copper, brass, titanium, and alloys thereof. Typically, the third metal may be any one of stainless steel, steel, copper, brass, titanium, and alloys thereof. Typically, the fourth metal is chosen from among, but is not limited to, aluminium, aluminium alloys, copper, copper alloys, brass, steel, stainless steel, low carbon steel, titanium, titanium alloys, and so on. Typically, the first metal and the fourth metal are comprised in the same metal family.

Typically, the first metal and the second metal belong to different metal families, though these two metals may also belong to the same metal family.

Typically, the first part and the second part are each formed as integral components.

In one particular embodiment of the connecting element the first metal is aluminium or an alloy thereof, and the second metal is stainless steel.

Optionally, the peripheral wall and said third portion may be joined together by welding resulting from the PMF process to provide a high strength joint, and the impact velocity associated with said PMF process may be in the range of about 200 m/sec to about 500 m/sec, for example. Optionally, the peripheral wall and said third portion are joined together by crimp forming resulting from the PMF process to provide a relatively low strength joint, and the impact velocity associated with said PMF process may be in the range of about 50 m/sec to about 200 m/sec.

In some embodiments, the magnitude of the radial gap (h2) between the first portion and an inner surface of said peripheral wall is related to a magnitude of the thickness (t1) of the peripheral wall by the expression:
h2=k*(t1)

where k is a coefficient having a value between about 0.5 and about 0.9.

The magnitude of the diameter D of a lumen associated with a forming coil of an apparatus configured to provide said MPF process may be related to the magnitude of the outer diameter D3 of said peripheral wall by the expression:—
D=D3+q

where q is between about 0.5 mm and about 5.00 mm, and preferably between about 1.5 mm and about 3.0 mm.

The magnitude of the axial length l₁ of a zone of the peripheral wall that is deformed over the first part may be related to a magnitude of the axial length l₀ and diameter D of a working zone provided by a lumen associated with a forming coil of an apparatus configured to provide said MPF process by the expressions:—
l₁=(0.5 to 0.9)*l₀ when D is greater than l₁
l₁=l₀ when D is less than or equal to l₁

The present invention is also related to a method for producing a bimetallic connecting element, comprising:

providing a first part made from a first metal, and having a first portion adapted for being fixedly attached to a structure, and a second portion comprising a peripheral wall defining a cavity;

providing a second part made from a second metal, and having a third portion, concentrically receiving said third portion with respect to said cavity and fixing said third portion with respect to said first part by means of a pulse magnetic forming (PMF) process comprising impacting said peripheral wall onto said third portion, wherein the second part comprises a fourth portion adapted for attaching thereto another component made from a third metal;

wherein said structure is formed from a fourth metal that is compatible with said first metal.

In the method according to the invention, the first metal and said second metal typically have substantially different properties one from the other, for example, different electrical conductivities one from the other.

In another aspect of the invention, a method for connecting a component to a structure is provided, wherein said component and said structure are made from metals which are not compatible for preventing galvanic corrosion therebetween, the method comprising:

providing a bimetallic connector element made from two metals, a first metal that is compatible with the structure metal, and a second metal that is compatible with the component metal, wherein said two metals are joined in said connector in a manner such as to substantially prevent galvanic corrosion therebetween;

welding said bimetallic connector element to said structure, via the part of the connector made from the first metal, using a suitable welding process.

The bimetallic connector element is typically formed by means of a suitable pulse magnetic forming (PMF) process, i.e., by welding the first metal and the second metal via a PMF process, and is typically of the form and structure of the bimetallic connecting element of the invention.

The method may be applied to any suitable structure, including, for example, at least a portion of any one of a road vehicle, an aircraft, a sea-faring vehicle, an amphibious vehicle, a satellite, a spaceship, a missile, a substantially static structure, a dynamic structure, and so on. In particular, the structure may comprise any one of a chassis, a metal body, a ship's hull, external skin of a vehicle, internal structure of a vehicle, a metal enclosure, a swinging bridge, and the like.

The first metal may be chosen from among aluminium, aluminium alloys, copper, copper alloys, brass, steel, stainless steel, low carbon steel, titanium, titanium alloys, for example. The second metal is chosen from among stainless steel, steel, copper, brass, titanium, and alloys thereof, for example. The structure may be made from a metal is chosen from among aluminium, aluminium alloys, copper, copper alloys, brass, steel, stainless steel, low carbon steel, titanium, titanium alloys, for example. The first metal and the metal from which said structure is made are comprised in the same metal family.

The welding process may comprise, for example, any one of fusion welding, beam welding, resistance welding, solid state welding, and the like. In particular, the welding method may comprise any one of GTAW (gas tungsten arc welding), GMAW (gas metal arc welding), LBW (laser beam welding), EBW (electron beam welding), RSW (resistance spot welding, SW (seam welding), PW (protection welding). PRW (pulse resistance welding), stud welding, FRW (friction rotating welding), FOW (forge welding), friction stir welding, friction spot welding, and so on.

Thus, in certain industrial applications where there is a need to connect components made from different metals, which often have significantly different properties, such as for example electrical conductivities, bimetallic connectors of the present invention may be useful, for example, in vehicles such as ambulances and fire trucks, when requiring to screw or rivet aluminium panels to stringers using steel bolts, or when requiring to weld together a steel component to an aluminium chassis or another component. In another application, the bimetallic connector of the invention is useful for facilitating the grounding of the aluminium body or chassis of a vehicle, for example, using a copper wire connection, and typically a steel screw or bolt is required on which to attach the copper wire or cable, as aluminium is generally lacks the necessary mechanical strength for such a connection.

In each case, the connectors of the present invention substantially avoid or minimize galvanic corrosion that may otherwise occur in the contact area between the metals having significantly different electrical conductivities. While such corrosion problems are not typically encountered when using stainless steel, stainless steel is not generally suitable for welding, since a relatively brittle compound tends to form at the weld, and it is generally more desirable to weld than to bolt a steel component to an aluminium component when these components are to se subjected to dynamic forces, such as in a vehicle body and chassis: the connectors of the present invention are useful in enabling such steel components to be effectively welded in place.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 illustrates, in cross-sectional side view, a first embodiment of the present invention, inserted in the lumen of a PMF device.

FIG. 2a and FIG. 2b illustrate, in isometric view, the embodiment of FIG. 1 before and after undergoing PMF treatment.

FIG. 3a illustrates in cross-sectional view, and FIGS. 3b to 3d in partial isometric view, various modifications of the embodiment of FIG. 1.

FIG. 4 illustrates, in cross-sectional side view, a second embodiment of the present invention, inserted in the lumen of a PMF device.

FIG. 5 illustrates, in cross-sectional side view, a variation of the embodiment of FIG. 4 after a PMF process is applied thereto, and welded to a structure and comprising a component fixed thereto.

FIG. 6 illustrates in fragmented cross-sectional side view a variation of the abutment edge of the embodiment of FIGS. 4 and 5.

FIGS. 7(a) to 7(d) illustrate in cross-sectional side view, a number of variations of the embodiment of FIG. 4 before a PMF process is applied thereto.

FIG. 8 illustrates, in cross-sectional side view, a third embodiment of the present invention, prior to undergoing PMF treatment.

FIG. 9 illustrates, in isometric view, the embodiment of FIG. 8 fixed onto a structure using a solid state welding method.

FIG. 10 illustrates, in cross-sectional side view, a variation of the embodiment of FIG. 1 fixed onto a structure using a solid state welding method.

FIG. 11 illustrates, in isometric view, the embodiment of FIG. 8 fixed onto a structure using a fusion welding method.

FIG. 12 illustrates, in isometric view, the embodiment of FIG. 8 fixed onto a structure using a beam welding method.

### DETAILED DESCRIPTION OF THE INVENTION

According to a first aspect of the invention, a bimetallic connecting element, and its method of manufacture are provided.

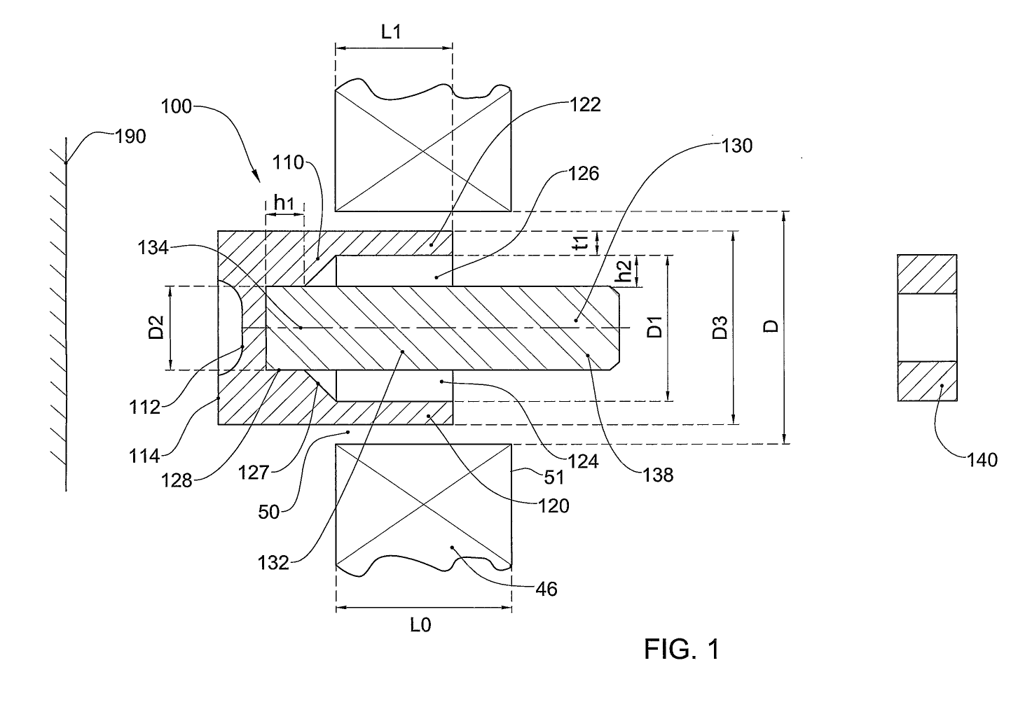

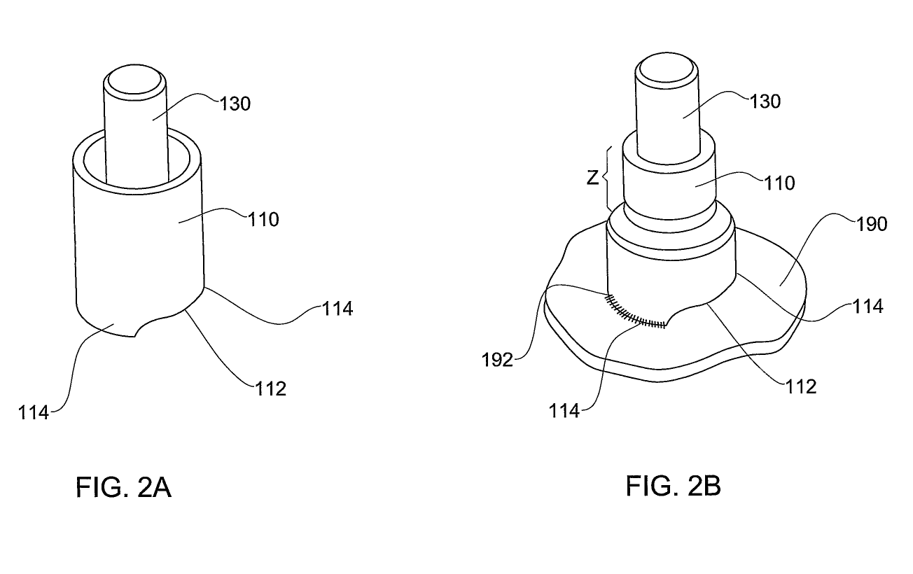

A first embodiment of the invention, according to the first aspect of the invention, is illustrated in FIGS. 1, 2a, and 2b, and comprises a bimetallic connecting element, generally designated 100, having a first integral part 110 made from a first metal, and a second integral part 130 made from a second metal. The second part 130 is adapted for attaching thereto a component 140 made from a third metal that is generally compatible with said second metal, while the first part 110 is adapted for being joined or attached to a structure 190 made from a fourth metal that is generally compatible with said first metal.

The first part 110 is generally cylindrical and comprises at one longitudinal end thereof a first portion in the form of a base 112, which is particularly adapted for enabling the same to be welded onto a structure 190, made from said fourth metal, typically the same metal or same metal family as the aforesaid first metal. For this purpose, the base 112 comprises, in this embodiment, a pair of diametrically opposed toes 114 projecting therefrom in a longitudinal direction. In other embodiments there may be a greater number of toes disposed as desired with respect to the periphery of the base 112. Alternatively, the base 112 may be adapted in a different manner to enable welding to the structure 190.

When it is desired to fixedly connect the connecting element 100 to another structure 190, welds 192 are formed between the toes 114 and the surface of the component 190. The toes 114 advantageously provide discrete anchoring points for the base 112 with respect to the structure 190. For example, such an arrangement may allow water to drain from between the base and the component 190, and thus does not allow water to accumulate within the base after the welding process.

The welding process may include any suitable welding process, for example:—
fusion welding, such as GTAW (gas tungsten arc welding) or GMAW (gas metal arc welding), and so on (exemplified in FIG. 2b);
beam welding, including for example LBW (laser beam welding) or EBW (electron beam welding), and so on;
resistance welding such as for example RSW (resistance spot welding, SW (seam welding), PW (protection welding). PRW (pulse resistance welding), stud welding, and so on;
solid state welding, including for example FRW (friction rotating welding), FOW (forge welding), friction stir welding, friction spot welding, and so on.

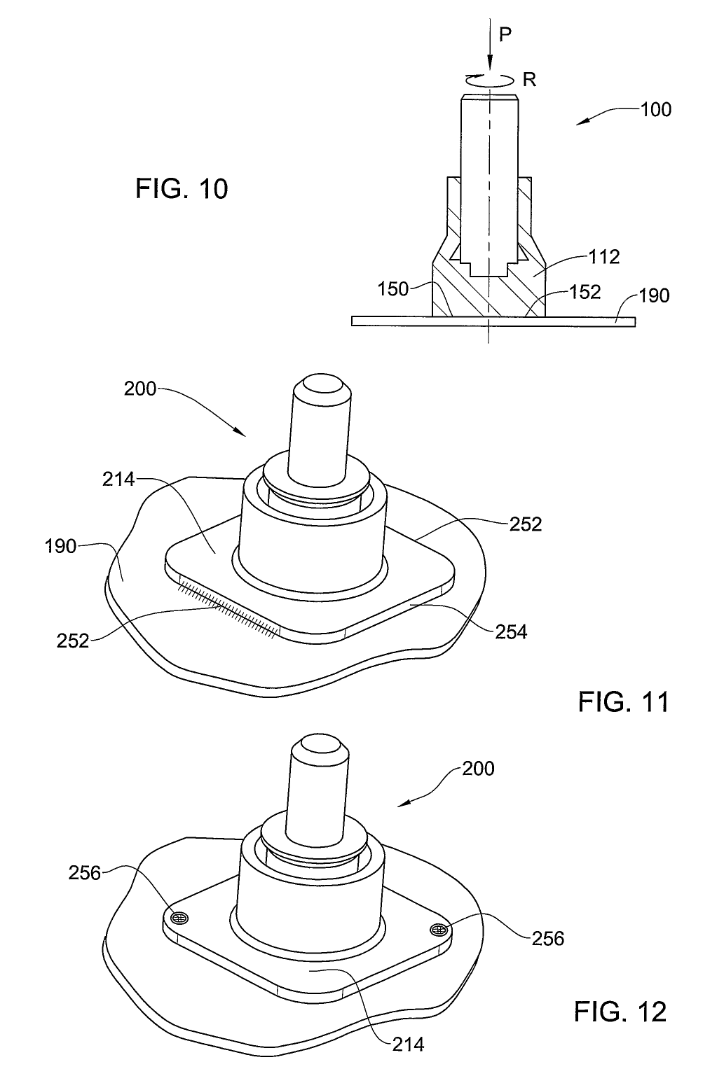

In the FRW example illustrated in FIG. 10, the base 112 does not comprise toes 114, but rather the free end 150 of the base is rotated at a suitable high speed while in abutting contact with the structure 190, so that a friction rotated weld 152 is formed in the interface between the base 112 and the structure 190 when a suitable pressure P and relative rotation R are applied to the member 100. Of course, the free end 150 may be solid cylindrical as illustrated in FIG. 6, or alternatively tubular, in the latter case the annular edge of the end 150 forming the FRW weld with the structure 190.

The first part 110 comprises at a second longitudinal end opposed to said base 112 a second portion 120 of diameter D3 comprising a peripheral wall 122, and defining a cavity 124 of diameter D1. Thus, as opposed to the generally solid non-hollow base 112, the second portion 120 is generally hollow. The peripheral wall 122 is typically of substantially uniform radial thickness t1, and while typically tubular, may comprise any suitable cross-section, for example oval or polygonal. In particular, the cavity 124 has an open longitudinal end 126, and a longitudinally opposed closed end comprising an axial recess or concavity 128, coaxially disposed with respect to said cavity 124, and having diameter D2 and depth h1. Advantageously, a bell mouth or chamfered section 127 connects the cavity 124 to the concavity 128. The concavity 128 acts as a seating structure for receiving the inward facing free end 134 of the second part 130. In other embodiments, the first portion of said first part may be formed, preferably integrally, with any seating structure for receiving the free end 134 and may include, for example, an annular stepped recess, a plurality of stops or tabs, and so on, for example, such as to hold in place and enable said second part to be coaxially aligned with respect to said first part at least prior to applying said PMF process to said element.

In this embodiment, the second part 130 of connector 100 is in the form of a cylindrical stem having a first portion 132, and comprising a longitudinal end 134 that is receivable, preferably in a tight-fitting fashion, with respect to concavity 128. While the second part 130 is substantially solid, i.e., non-hollow, in other embodiments it is possible for this part to be hollow or partially hollow, typically so long as it is still mechanically strong enough to enable the PMF process to be applied to it (as will become clearer below) without significantly buckling this part. The concavity 128 thus allows the first part 110 and the second part 130 to be coaxially aligned and held in position in a simple manner until the PMF; process is applied, as described below. Thus, the diameter of end 134 is just less than D2, and the concavity 128 facilitates the seating of the first portion 132 in a concentric manner with respect to the cavity 124, leaving a radial gap h2 between the first portion 132 and the internal surface of the cavity 124. Alternatively, the diameter of end 134 may be substantially equal to or slightly greater than D2, and the second part 130 has to be forced into axial engagement with the first part 110.

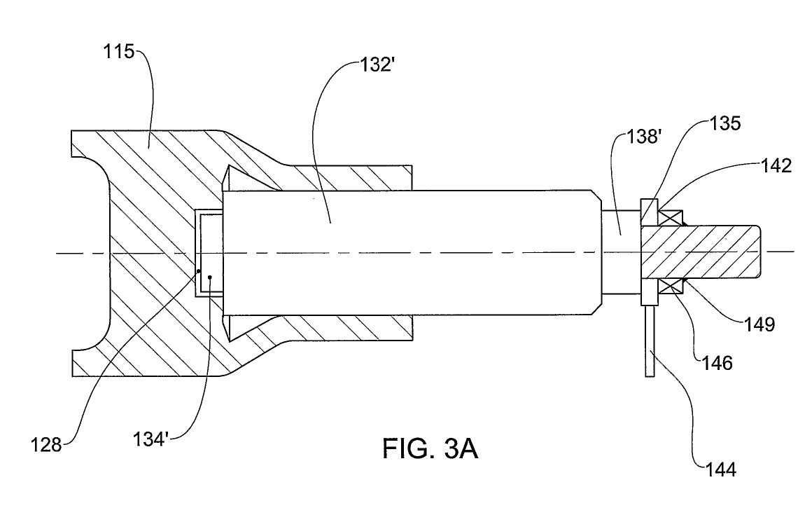

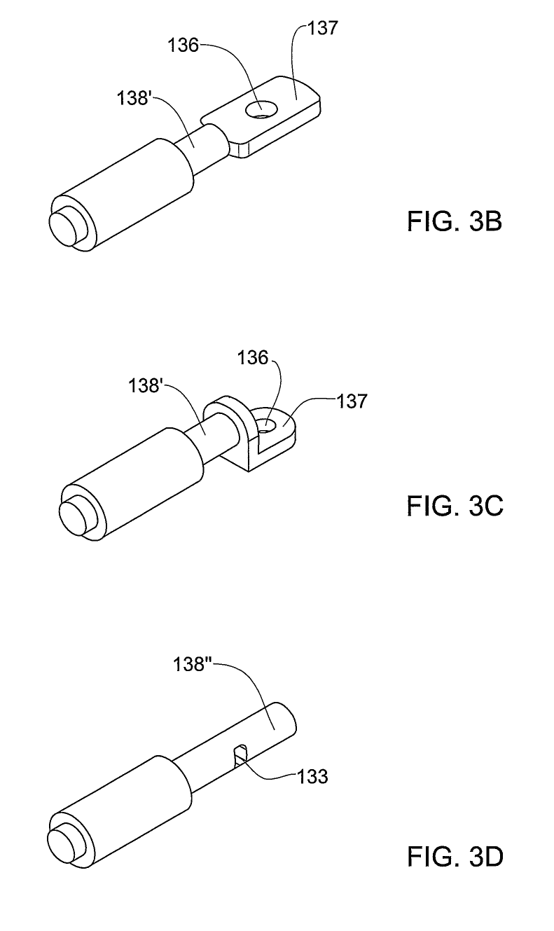

In other embodiments, the second part 130 may other than cylindrical, having any suitable cross-section, for example oval or polygonal. Also, the second part 130 may be prismatic, having substantially constant cross-section along its longitudinal length. Alternatively, and referring to FIG. 3a, for example, the first portion 132′ of the second part may comprise a diameter greater than D2, but less than D1, and the end 134′, of smaller diameter D2, coaxially projects from the first portion 132′ in a stepped manner, to be received in the concavity 128. Optionally, the first portion 132′ may also be stepped at the longitudinal end thereof that is adjacent to the second portion 138′, comprising one or more annular faces 135 that facilitate the location on the second portion of a washer 142 or the like that may carry an earthing cable 144, for example. A nut 146 may be used in the normal manner to secure the washer to the first portion 132′, and the nut 146 may optionally be welded in place at 149.

Thus, the second portion 138′ or 138, longitudinally opposed to first portion 132, is adapted for connecting thereto another component 140, which may be made from the said second metal, or indeed from another metal that is compatible therewith, i.e., said third metal. Accordingly, the second portion 138 or 138′ may comprise a threaded portion adapted for screwing thereonto a nut or the like. Alternatively, the second portion 138 or 138′ of the second part may comprise a flattened portion, for welding or soldering thereon, a cable or wire. Alternatively, and referring to FIGS. 3b and 3c, for example, the second portion 138′ of the second part may comprise a flattened portion 137, having a bore 136 therethrough, which may be threaded or smooth, to enable a threaded bolt to be connected thereto to secure, for example, another component, to the connector 100. Alternatively, and referring to FIG. 3d, for example, the second portion 138″ of the second part comprises a transverse bore 133, which may be threaded or smooth.

The second part 130 is fixed with respect to the first part 110 using a process that generates a suitable magnetic pulse force such as to impact the peripheral wall 122 onto the first portion 132. Suitable pulse magnetic forming (PMF) processes are described in U.S. Pat. No. 5,824,998 (assigned to the present assignee), and the contents of this reference are incorporated herein in their entirety. The disclosed PMF processes may be applied to the present invention, mutatis mutandis. In particular, having seated the second part 130 with respect to the second part 110 by means of concavity 128, such that the first portion 132 is concentrically and coaxially disposed with respect to the peripheral wall 134, the as yet unfixed connector 100 is inserted in the lumen 50 of a forming coil 46 (FIG. 1). The forming coil 46 is operatively connected to suitable charging and operating equipment (not shown), and a suitable current is discharged in the coil 46 to produce a PMF effect with respect to the portions of the connector 100 accommodated in the lumen 50, resulting in a constriction of the peripheral wall 134 and impaction thereof onto the first portion 132 along a zone Z (FIG. 2b).

Essentially, a pulse current generator creates a pulse of high current in the coil 46, and this current creates a high magnetic field in the coil's working zone, i.e., the lumen 50. The magnetic field creates eddy currents in the outer layer of the peripheral wall 122, and a mechanical force in a radial direction towards the axis 99 of the connector, since this is coaxial with the lumen 50, as a result of the interaction between the magnetic field and the eddy currents. The peripheral wall 122 thus collapses under the mechanical force generated with high speed, typically in the hundreds of meters per second, and is cold welded or crimped with respect to the first portion 132.

Depending on the PMF conditions, in particular the impact velocity and minimum dynamic angle between the peripheral wall 122 and the first portion 132, these two components may be joined together by welding, providing a high strength joint between the two components. For example, impact velocities in the range of about 200 m/sec to about 500 m/sec may provide a high strength welded joint, while impact velocities in the range about 50 m/sec to less than about 200 m/sec may provide a crimp formed joint.

The impact velocity v and the minimum dynamic angle α are discussed in the two references: Pearson J., Metal working with explosive, J. METALS, 1960, v 12, No 9, p 673-681; Bahrani A. S., Crossland B., Explosive welding and cladding. An introductory survey and preliminary results, PROCEEDINGS of INSTITUTE MECHANICAL ENGINEERS, 1965, v 79, pt 7, p 264. The contents of these references are incorporated herein in their entirety.

Preferably, the magnitude of the radial gap h2 between the first portion 132 and the inner surface of the peripheral wall 122 is related to the magnitude of the thickness t1 of the peripheral wall by the expression:
h2=k*(t1)

where k is a coefficient having a value between about 0.5 and about 0.9.

Typically, the optimal value of k depends on a number of empirical factors, such as for example the mass of the moving parts—i.e., the first part 120—the magnitude and duration of the PMF force being generated and applied to the first part 120, the yield strength of the part 120, the specific electrical resistance of the various parts of the connecting element, the properties of the first and second metals, and so on. The above expression for h2 is a convenient tool for designing the connecting element, and works well in practice.

Preferably, the magnitude of the diameter D of the lumen 50 is related to the magnitude of the outer diameter D3 of the peripheral wall 122 by the expression:—
D=D3+q

where q is between about 1.5 mm and about 3.0 mm.

In other words, the magnitude of the radial gap between the peripheral wall 122 and the inner walls of the coil 46 defining the lumen 50 is preferably between about 0.75 mm and about 1.5 mm.

The optimal value for q within this range typically depends on a number of factors, and typically presents a compromise between a low value that increases the PMF force and a high value that reduces electrical effects on the bimetallic element due to the PMF process. Accordingly, the optimal value for q can be affected by the type of insulating material—and the properties thereof—used for the coil 46, the magnitude of the working voltage, production details (for example how many connecting elements are processed by the coil per hour, etc), the type and duty of the cooling system used for the coil 46, and so on. The above expression for D3 is a convenient tool for designing the connecting element, and works well in practice.

Preferably, the magnitude of the axial length l₁ of the zone Z (FIG. 2b) of the peripheral wall 122 that is deformed over the first part 132, i.e., the axial penetration of the peripheral wall 122 into the lumen 50, is related to the magnitude of the axial length l₀ of the working zone provided by the lumen 50 and to the diameter D of the lumen 50 by the expressions:—
l₁=(0.5 to 0.9)*l₀ when D is greater than l₁
l₁=l₀ when D is less than or equal to l₁

Thus, for relatively long connectors, where the required impact zone between the peripheral wall 122 and the first part 132 has an axial extent that is equal or greater in magnitude than the diameter of the lumen 50, the peripheral wall 122 is fully inserted into the lumen 50 until the leading edge of the peripheral wall 122 is co-planar with the far edge 51 of the lumen 50. Conversely, for relatively shorter connectors, where the required impact zone between the peripheral wall 122 and the first part 132 has an axial extent that less than the diameter of the lumen 50, the peripheral wall is only partially inserted into the lumen 50 until the leading edge of the peripheral wall 122 is between about 0.1*D to about 0.5*D with respect to the far edge 51 of the lumen 50. In the latter case, the greatest magnetic field strength acts on the free end of the peripheral wall 122, resulting in a higher impact velocity for this part of the peripheral wall 122, which in turn produces a strong bond.

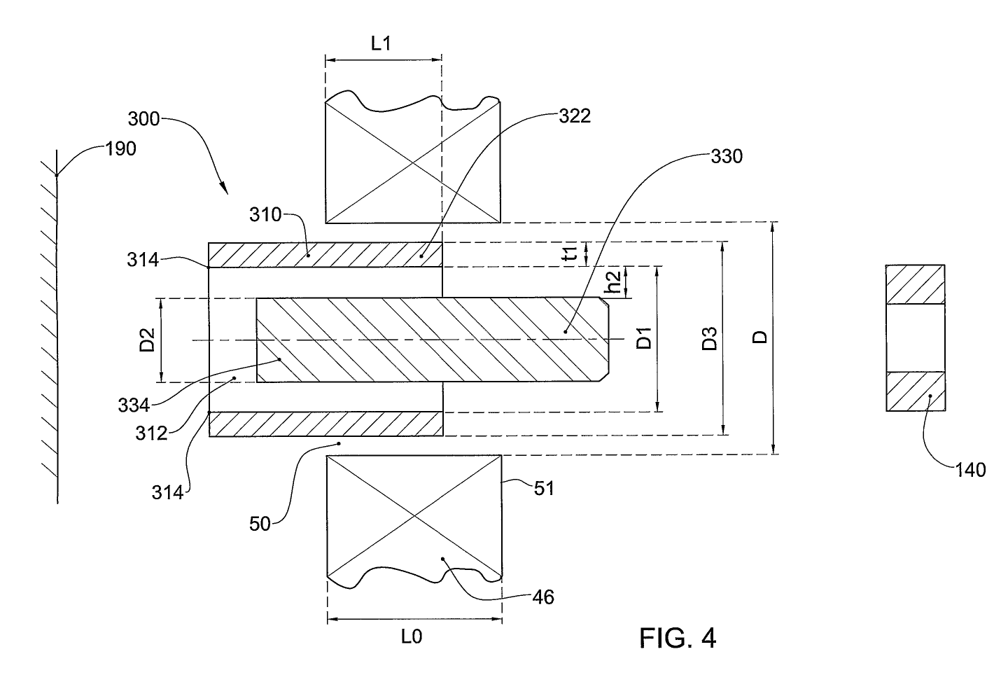

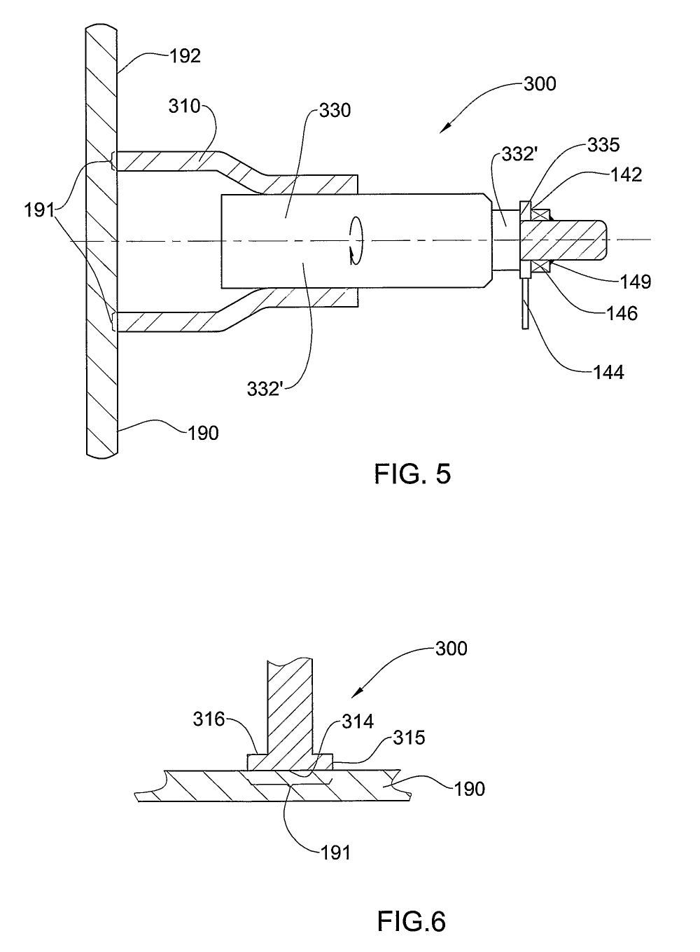

A second embodiment of the present invention, generally designated 300, is illustrated in FIGS. 4 and 5, and comprises all the features, elements and modifications of the first embodiment, as described herein mutatis mutandis, with the differences that will become apparent in the description below.

As for the first embodiment, this embodiment comprises a first part 310 having at one longitudinal end thereof a first portion in the form of a base 312, which is particularly adapted for enabling the same to be welded or otherwise joined, for example by riveting or bolting, onto another component or structure 190, made from the aforesaid fourth metal which is compatible with said first metal. In this embodiment, the first part 310 is axially hollow, and thus the second part 330 is aligned with the first part 310 such that their longitudinal axes are coaxial. This axial alignment may be carried out in any suitable manner. As with the first embodiment, the first part has a second portion 322 that receives a second portion 334 of the second part 330 in overlapping fashion, and these aligned components are introduced into the lumen 50 of a suitable PMF forming coil 46 to an axial depth L1, and a PMF process is then applied to secure the second portion 322 onto the second part 330, similarly to that described above for the first embodiment, mutatis mutandis.

Further, rather than having toes, the first part 310 is particularly adapted for being joined to said structure 190 by means of friction welding or the like, and thus the first portion 312 of the first part 310 is substantially cylindrical, having an abutting end in the form of a planar annular edge 314 for abutment to a surface 192 of a part 191 of the structure 190. Typically, the first part 310 is cylindrical, but alternatively may be frustoconical, or comprises a stepped cross-section between the base 312 and the second portion 322, for example. Accordingly, part 191 is correspondingly planar and while typically orthogonal to the longitudinal axis 99 of the connector 300, part 191 is substantially parallel with the plane of the edge 314. Accordingly, edge 314 and part 191 can come into abutting contact at a mutually defined contact plane, and the connector 191 and/or the structure can be rotated at suitable speed about an axis orthogonal to this plane and centered on the geometric center of the edge 314, typically the said axis of the connector 300, wherein appropriate pressure is also applied along this rotational axis 99 to create a friction weld between the edge 314 and the part 191. For this purpose, it is optionally possible in some applications of connector 300 for the plane defined by the edge 314 to be at an angle other than orthogonal to the axis of the connector 300.

Optionally, the second part 330 may be cylindrical or other than cylindrical, having any suitable cross-section, for example oval or polygonal. Also, the second part 330 may be prismatic, having substantially constant cross-section along its longitudinal length. Alternatively, and as illustrated in FIG. 5, for example, the first portion 332′ of the second part may comprise any suitable diameter less than D1, and further optionally, the first portion 332′ may also be stepped at the longitudinal end thereof that is adjacent to the second portion 338′, comprising one or more annular faces 335 that facilitate the location on the second portion of a washer 142 or the like that may carry an earthing cable 144, for example. A nut 146 may be used in the normal manner to secure the washer to the first portion 332′, and the nut 146 may optionally be welded in place at 149.

Optionally, and as illustrated in FIG. 6, the edge 314 may comprise an inner lip 315 and/or an outer lip 316 to increase the abutment area of the edge 314 with respect to the part 191, and thus enable a stronger weld to be created therebetween.

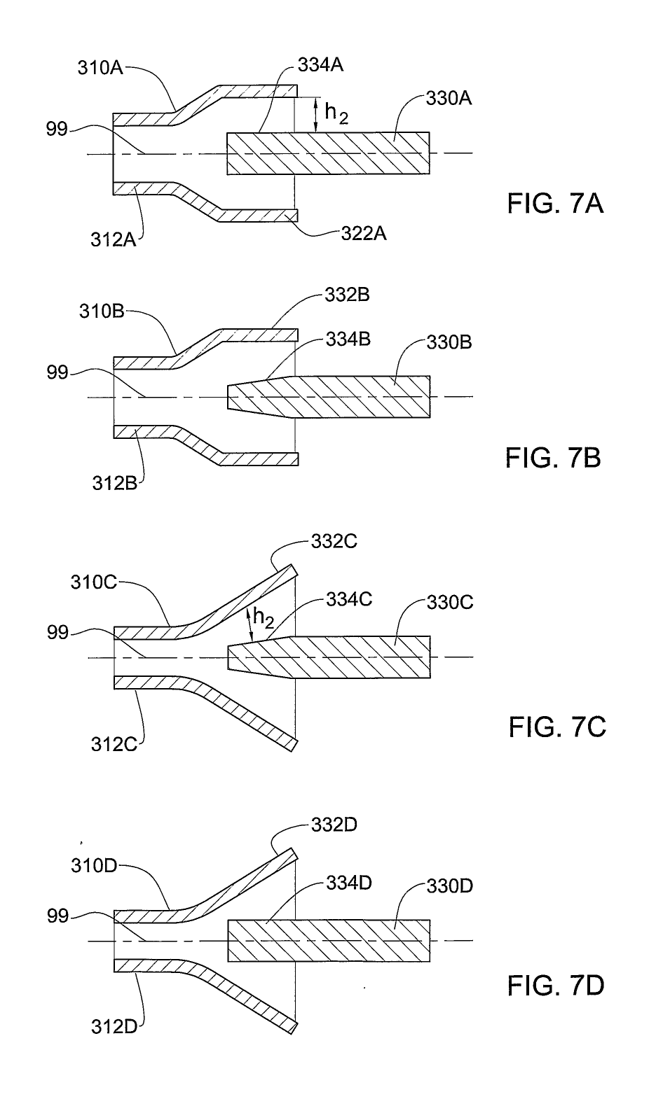

Variations of the second embodiment are illustrated in FIGS. 7(a) to 7(d), and these variations are also applicable, mutatis mutandis, to other embodiments of the invention.

For example, and referring to FIG. 7(a), the first portion 312A of the first part 310A typically comprises an internal diameter about the same as the external diameter of the first portion 334A, and furthermore, the second portion 322A of the first part 310A has an increased diameter with respect to first portion 312A, such as to provide a substantially constant spacing h2, as described above, mutatis mutandis. The first portion 334A is substantially of constant cross-section.

Referring to FIG. 7(b), the first portion 312B of the first part 310B typically also comprises an internal diameter about the same as the external diameter of the first portion 334B or alternatively significantly smaller, and furthermore, the second portion 322B of the first part 310B has an increased diameter with respect to first portion 312A. However, the first portion 334B of the second part 330B is tapered, and thus the spacing between the first portion 334B and the second portion 322B varies axially.

Referring to FIG. 7(c), the first portion 312C of the first part 310C typically also comprises an internal diameter about the same as the external diameter of the first portion 334C or alternatively significantly smaller, and furthermore, the second portion 322C of the first part 310C is frustoconical or fluted, having a diameter that increases along the axis 99, as illustrated. The first portion 334C of the second part 330C is tapered, and thus the spacing between the first portion 334C and the second portion 322C may vary axially or be maintained at h2, depending on the tapering angles of the second portion 322C and the first portion 334C.

Referring to FIG. 7(d), the first portion 312D of the first part 310D typically also comprises an internal diameter about the same as the external diameter of the first portion 334D or alternatively significantly smaller, and furthermore, the second portion 322D of the first part 310D is frustoconical or fluted, having a diameter that increases along the axis 99, as illustrated. The first portion 334D of the second part 330D is of constant section, and thus the spacing between the first portion 334D and the second portion 322D varies axially.

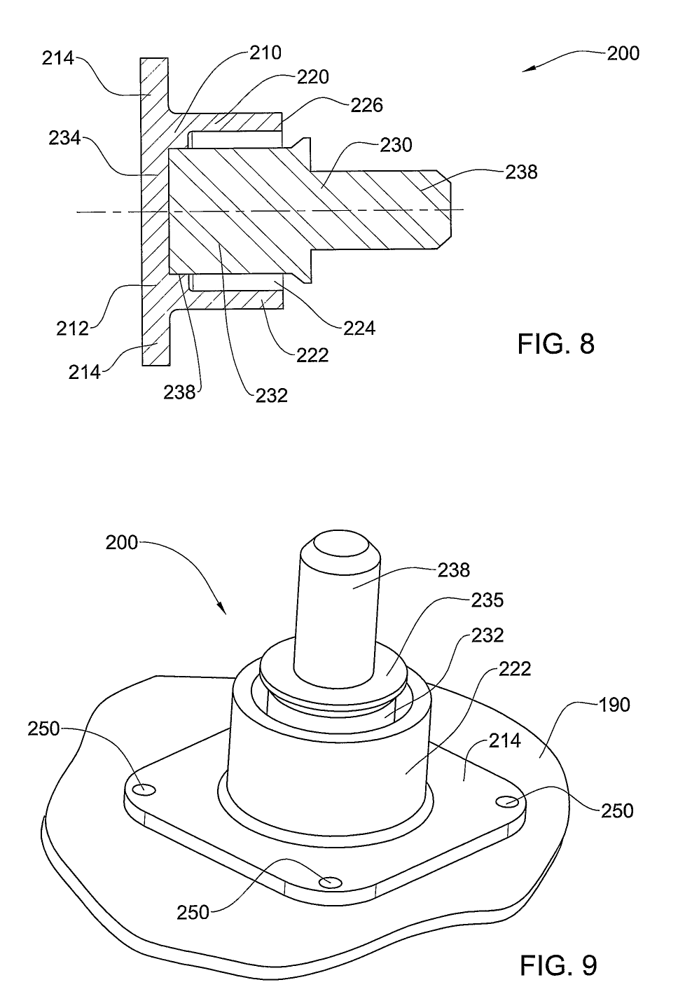

A third embodiment of the present invention, generally designated 200, is illustrated in FIGS. 8 and 9, and comprises all the features, elements and modifications of the first embodiment, as described herein mutatis mutandis, with the differences that will become apparent in the description below.

As for the first embodiment, this embodiment comprises a first part 210 having at one longitudinal end thereof a first part in the form of a base 212, which is particularly adapted for enabling the same to be welded or otherwise joined, for example by riveting or bolting onto another component, made from the aforesaid fourth metal which is compatible with said first metal. In this embodiment, rather than having toes, the first part 210 is adapted for being joined to said structure 190 by comprising a first portion 212 having an extended base in the form of a peripheral flange 214 circumscribing the periphery of the first portion 212 at the longitudinal end thereof. The flange 214 may be substantially rectangular in plan form, for example, as illustrated in FIGS. 8 and 9,—or alternatively annular or any other form—and provides a relatively large area for enabling the same to be welded, riveted, bolted or otherwise fixedly joined onto a structure 190, such as for example a chassis or vehicle body. For example, and referring to FIG. 9 the flange 214 may be stir-welded to another component via four stir-welds 250, one at each corner of the flange 214. Alternatively, the stir welds 250 may be replaced with any solid state welding, including for example FRW (friction rotating welding), FOW (forge welding), friction stir welding, friction spot welding, and so on.

The flange 214 thus comprises a bottom abutting surface that is shaped according to the surface of the part of the structure on which the connecting element 200 is to be fixedly mounted. Typically, this part of the structure is substantially planar, and thus the flange 214 is also planar. However, this part of the structure may be any desired shape, for example convex, concave, cylindrical and so on, and thus the bottom surface of the flange is complementarily shaped to abbutingly fit thereon.

Alternatively, and as illustrated in FIG. 11, fusion welds 252, applied by any suitable fusion welding method, such as for example GTAW (gas tungsten arc welding) or GMAW (gas metal arc welding), and so on, may be used for welding the flange 214 to structure 190. The fusion welds are typically formed between at least part of periphery 254 of the flange 214 and the structure 190.

Alternatively, and referring to FIG. 12, beam welds 256 using any suitable beam welding method, including for example LBW (laser beam welding) or EBW (electron beam welding), and so on, may be used for welding the flange 214 to structure 190. The beam welds 256 are typically formed between the flange 214 and the structure 190.

(It should be noted that FIGS. 9, 11 and 12 show the connector 200 prior to the PMF process being applied to it. While in some cases it is possible to first weld the flange 214 to the structure 190, and then apply the PMF process to produce the bimetallic element 200 in situ welded to the structure 190, the standard procedure is usually the reverse of this, i.e., the bimetallic element 200 is usually first formed, and subsequently joined to structure 190.)

Alternatively, resistance welds using any suitable resistance welding such as for example RSW (resistance spot welding, SW (seam welding), PW (protection welding). PRW (pulse resistance welding), stud welding, and so on, may be used for welding the flange 214 to structure 190.

As with the first embodiment, the first part 210 comprises at a second longitudinal end opposed to said base 212 a second portion 220 comprising a peripheral wall 222, and defining a cavity 224 having an open longitudinal end 126, and a longitudinally opposed concavity 228, coaxially disposed with respect to said cavity 224. In the illustrated embodiment, the second part 230 of connector 200 is in the form of a cylindrical stem having a first portion 232 comprising a longitudinal end 234 that is receivable with respect to concavity 228 for seating of the first portion 232 in a concentric manner with respect to the cavity 224, leaving a radial gap between the first portion 232 and the internal surface of the cavity 224. Other variations of this embodiment are possible, similar to those described for the first embodiment, mutatis mutandis. The first portion 232 may further comprise a flared portion having an annular face 235 facing away from the first part 230 that facilitates the location and seating of a washer or the like that may carry an earthing cable (not shown), for example, and this may be secured by a nut, for example.

The second part 230 is fixed with respect to the first part 210 using a PMF process, as described for the first embodiment, mutatis mutandis, and these two components may be joined together by welding via the PMF process, providing a high strength joint.

In most embodiments of the invention, the first metal and the second metal are generally different one from the other and have different properties, such as for example electrical conductivities. Alternatively, the first and second metals may comprise the same metal or comprise metals from the same metal family.

The first metal includes any one of but is not restricted to the group of metals: aluminium, and its alloys, copper and copper alloys, brass, steel, stainless steel, low carbon steel, titanium and its alloys.

The second metal includes any one of but is not restricted to the group of metals: stainless steel, steel, copper, brass, nickel, titanium, and their alloys.

The third metal may be the same as the second metal, or may be different therefrom, and may include any one of but is not restricted to the group of metals: stainless steel, steel, copper, brass, nickel, titanium, and their alloys.

The fourth metal is typically the same metal as the first metal, or belongs to the same family of metals as the first metal, and typically includes any one of but is not restricted to the group of metals: aluminium, and its alloys, copper and copper alloys, brass, steel, stainless steel, low carbon steel, titanium and its alloys.

Table 1 below provides some non-limiting examples of possible combinations of first second metals in a connector according to the invention that may be fixedly connected to a structure made from fourth metals.

TABLE 1
EXAMPLES OF POSSIBLE COMBINATIONS OF FIRST SECOND METALS IN
A CONNECTOR ACCORDING TO THE INVENTION THAT MAY BE
FIXEDLY CONNECTED TO A STRUCTURE MADE FROM FOURTH METALS

| Type of | Second | | |
|---|---|---|---|
| connector | metal | First metal | Fourth metal |
| Aluminum + Steel | Steel | Any one of: Aluminum and | Any one of: Aluminum and |
| | | its Alloys such as for | its Alloys such as for |
| | | example Al1, Al3, Al6, | example Al1, Al3, Al6, |
| | | Al5, . . . | Al5, . . . |
| Aluminium + Stainless | Stainless | Any one of: Aluminum and | Any one of: Aluminum and |
| Steel | Steel | its Alloys | its Alloys |
| Aluminium + Copper | Copper | Any one of: Aluminum and | Any one of: Aluminum and |
| | | its Alloys | its Alloys |
| Aluminum + Brass | Brass | Any one of: Aluminum and | Any one of: Aluminum and |
| | | its Alloys | its Alloys |
| Copper + Brass | Brass | Any one of: Copper and its | Any one of: Copper and its |
| | | Alloys | alloys |
| Copper + Steel | Steel | Any one of: Copper | Any one of: Copper and its |
| | | and its Alloys | alloys |
| Brass + Steel | Steel | Any type of Brass | Any type of Brass |
| Brass + Stainless | Stainless | Any type of Brass | Any type of Brass |
| Steel | Steel | | |
| Steel + Steel | Steel | Any one of: Steel and any | Any one of: Steel and any |
| | | steel alloys | steel alloys |
| Steel + Stainless | Stainless | Any one of: Steel and any | Any one of: Steel and any |
| Steel | Steel | steel alloys | steel alloys |
| Stainless Steel + Ti | Titanium & | Any type of Stainless Steel | Any type of Stainless Steel |
| and Ti Alloys | its alloys | | |
| Ti and Ti Alloys + Ni | Nickel & its | Any one of: Titanium and | Any one of: Titanium and |
| and Ni Alloys | alloys | its alloys | its alloys |

Typically, it is advantageous for the softer metal between the first metal and the second metal to be impacted onto the harder metal using the magnetic pulse force. However, it is also possible to reverse the arrangement, such that the second part is made having a peripheral wall defining a cavity for receiving a portion of the first part, and this peripheral wall is impacted onto the first part.

The bimetallic connector according to the present invention may be adapted for use as an earth connector by fixing the first part to the component or structure to be earthed, for example, an aluminium chassis, by conventional welding techniques for example. A copper cable, for example, may then be connected to the first portion of the second part using any suitable connection configuration, for example a nut screwed to this component. Such a connector is typically aluminium/copper or the like.

The bimetallic connector according to the present invention may also be adapted for use as a connecting bolt by fixing the first part to one of the components to be bolted, for example, an aluminium chassis, by conventional welding techniques for example. A second component, for example a steel rigger, may then be connected to the first portion of the second part using any suitable connection configuration, for example a nut screwed to this component, or by welding the second component directly to the aforesaid first portion of the second part.

Thus according to a second aspect of the invention, a method is provided for joining a component made from said third metal to a structure made of said fourth metal, by employing a bimetallic connecting element made from said first metal and said second metal. According to this connection method, the bimetallic connecting element comprises a first part made from said first metal which is fused onto a second part made of said second metal in a manner such as to substantially prevent galvanic corrosion therebetween, or to prevent a degradation of the mechanical properties of either one of the two metals, particularly at the contact area thereof, in particular using a PMF process. The bimetallic connecting element is fixedly joined to the structure by welding the aforesaid first part to the structure using any suitable welding method. The welding method may comprise for example, but is not limited to, any of the following methods, which have been described in more detail with respect to the first and second embodiments of the connector of the invention:—
fusion welding, such as GTAW (gas tungsten arc welding) or GMAW (gas metal arc welding), and so on (exemplified in FIG. 2b);
beam welding, including for example LBW (laser beam welding) or EBW (electron beam welding), and so on;
resistance welding such as for example RSW (resistance spot welding, SW (seam welding), PW (protection welding). PRW (pulse resistance welding), stud welding, and so on;
solid state welding, including for example FRW (friction rotating welding), FOW (forge welding), friction stir welding, friction spot welding, and so on.

In one particular embodiment of the connection method, the bimetallic connector element as described above for the first aspect of the invention may be used for connecting a component made from said third metal to a structure made from said fourth metal.

In the method claims that follow, alphanumeric characters and Roman numerals used to designate claim steps are provided for convenience only and do not imply any particular order of performing the steps.

Finally, it should be noted that the word “comprising” as used throughout the appended claims is to be interpreted to mean “including but not limited to”.

While there has been shown and disclosed exemplary embodiments in accordance with the invention, it will be appreciated that many changes may be made therein without departing from the spirit of the invention.

1-44. (canceled)

45. A bimetallic connecting element, comprising:
a first part made from a first metal, and having a first portion adapted for being attached to a structure, and a second portion comprising a peripheral wall defining a cavity; and
a second part made from a second metal, and having a third portion concentrically received with respect to said cavity and fixed with respect to said first part by means of a pulse magnetic forming (PMF) process comprising impacting said peripheral wall onto said third portion, and a fourth portion adapted for attaching thereto a component made from a third metal;
wherein said structure is made from a fourth metal that is compatible with said first metal.

46. A connecting element according to claim 45, wherein said first portion of said first part is formed with a seating structure for receiving a free end of said third portion such as to enable said second part to be coaxially aligned with respect to said first part at least prior to applying said PMF process to said element.

47. A connecting element according to claim 46, wherein said first portion of said first part is substantially solid, and said seating structure is formed as a concavity therein.

48. A connecting element according to claim 45, wherein said first portion is substantially tubular having an annular edge at an end thereof opposed to said second portion, said annular edge adapted for being fixedly attached to a structure by forming a suitable weld therebetween by means of any suitable welding method.

49. A connecting element according to claim 46, wherein said first portion comprises a plurality of spaced toes longitudinally projecting therefrom in a direction opposed to the said second part, wherein suitable welds may be formed between said toes and said structure.

50. A connecting element according to claim 46, wherein said first portion comprises a peripheral flange circumscribing a longitudinal end of the said first part opposed to said second part, wherein suitable weld may be formed between said flange and said structure by means of any suitable welding method.

51. A connecting element according to claim 45, wherein said element is adapted for being welded or bolted onto a structure, said structure being substantially orthogonal to a longitudinal axis of said element.

52. A connecting element according to claim 46, wherein:
optionally said fourth portion comprises a screw thread for enabling another component to be attached thereto;
optionally said fourth portion comprises a flattened section having a bore for enabling another component to be attached thereto;
optionally said third portion comprises an annular face juxtaposed with said fourth portion for enabling another component to be seated and attached thereto;
optionally said fourth portion adapted for welding thereto another component;
optionally said first metal and said second metal have substantially different properties; and
optionally said first metal and said second metal have substantially different electrical conductivities one from the other.

53. A connecting element according to claim 46, wherein optionally said first metal is chosen from among aluminum, aluminum alloys, copper, copper alloys, brass, steel, stainless steel, low carbon steel, titanium, titanium alloys;
optionally said second metal is chosen from among stainless steel, steel, copper, brass, titanium, and alloys thereof;
optionally said third metal is any one of stainless steel, steel, copper, brass, titanium, and alloys thereof; and
optionally said fourth metal is chosen from among aluminum, aluminum alloys, copper, copper alloys, brass, steel, stainless steel, low carbon steel, titanium, titanium alloys.

54. A connecting element according to claim 46, wherein;
optionally said first metal and said fourth metal are comprised in the same metal family;
optionally said first metal is aluminum or an alloy thereof and said second metal is stainless steel;
optionally said first part and said second part are each integrally formed parts;
optionally said first metal and second metal belong to different metal families; and
optionally said second part is elongate and substantially solid in cross-section.

55. A connecting element according to claim 46, wherein:
(A) optionally a magnitude of the radial gap (h2) between the third portion and an inner surface of said peripheral wall is related to a magnitude of the thickness (t1) of the peripheral wall by the expression:
h2=k*(t1)
where k is a coefficient having a value between about 0.5 and about 0.9;
(B) optionally a magnitude of the diameter D of a lumen associated with a forming coil of an apparatus configured to provide said PMF process is related to the magnitude of the outer diameter D3 of said peripheral wall by the expression:—
D=D3+q
where q is between about 1.5 mm and about 3.0 mm; and
(C) optionally a magnitude of the axial length l₁ of a zone of the peripheral wall that is deformed over the first part is related to a magnitude of the axial length l₀ and diameter D of a working zone provided by a lumen associated with a forming coil of an apparatus configured to provide said PMF process by the expressions:—
l₁=(0.5 to 0.9)*l₀ when D is greater than l₁
l₁=l₀ when D is less than or equal to l₁

56. An article of manufacture comprising a structure and at least one connecting element fixedly attached to said structure by means of a suitable welding method, wherein said connecting element is as defined in claim 45, said structure being made from said fourth metal.

57. An article according to claim 56, wherein at least a portion of said structure corresponding to and in abutting contact with said at least one element is substantially parallel to a plane defined by an abutting end of said first portion of said first part of said element.

58. An article according to claim 55, wherein said structure comprises at least a portion of any one of a road vehicle, an aircraft, a sea-faring vehicle, an amphibious vehicle, a satellite, a spaceship, a missile, a substantially static structure, a dynamic structure, and the like, or any one of a chassis, a metal body, a ship's hull, external skin of a vehicle, internal structure of a vehicle, a metal enclosure, a swinging bridge, and the like.

59. A method for producing a bimetallic connecting element, comprising:
providing a first part made from a first metal, and having a first portion adapted for being fixedly attached to a structure, and a second portion comprising a peripheral wall defining a cavity;
providing a second part made from a second metal, and having a third portion, concentrically receiving said third portion with respect to said cavity and fixing said third portion with respect to said first part by means of a pulse magnetic forming (PMF) process comprising impacting said peripheral wall onto said third portion, wherein the second part comprises a fourth portion adapted for attaching thereto another component made from a third metal;
wherein said structure is made from a fourth metal that is compatible with said first metal.

60. A method according to claim 59, comprising the step of aligning said second part with respect to said first part at least prior to applying said PMF process to said element, wherein said first portion of said first part comprises a seat formed therein for receiving a free end of said third portion.

61. A method according to claim 60, wherein:
optionally said first metal and said second metal have substantially different properties one from the other;
optionally said first metal and said second metal have substantially different electrical conductivities one from the other; and
optionally said peripheral wall and said third portion are joined together by welding resulting from the PMF process to provide a high strength joint, and further optionally wherein an impact velocity associated with said PMF process is in the range of about 200 m/sec to about 500 m/sec.

62. A method for connecting a component to a structure, wherein said component and said structure are made from metals which are not compatible for preventing galvanic corrosion therebetween, comprising:
providing a bimetallic connector element made from two metals, a first metal that is compatible with the structure metal, and a second metal that is compatible with the component metal, wherein said two metals are joined in said connector in a manner such as to substantially prevent galvanic corrosion therebetween;
welding said bimetallic connector element to said structure, via the part of the connector made from the first metal, using a suitable welding process.

63. A method according to claim 62, wherein said bimetallic connector element is formed by means of a suitable pulse magnetic forming (PMF) process.

64. A method according to claim 62, wherein said bimetallic connector element, comprising:
a first part made from a first metal, and having a first portion adapted for being attached to a structure, and a second portion comprising a peripheral wall defining a cavity; and
a second part made from a second metal, and having a third portion concentrically received with respect to said cavity and fixed with respect to said first part by means of a pulse magnetic forming (PMF) process comprising impacting said peripheral wall onto said third portion, and a fourth portion adapted for attaching thereto a component made from a third metal;
wherein said structure is made from a fourth metal that is compatible with said first metal.

65. A method according to claim 64, wherein said structure comprises at least a portion of any one of a road vehicle, an aircraft, a sea-faring vehicle, an amphibious vehicle, a satellite, a spaceship, a missile, a substantially static structure, a dynamic structure, and the like, or any one of a chassis, a metal body, a ship's hull, external skin of a vehicle, internal structure of a vehicle, a metal enclosure, a swinging bridge, and the like.
